(19) United States
(12) Patent Application Publication
(10) Pub. No.: US 2016/0143327 A1
(43) Pub. Date: May 26, 2016

(54) METHOD FOR PRODUCING DIET FOOD, USING OPUNTIA FICUS-INDICA FRUIT

(71) Applicant: Jiyoon MOON, Busan (KR)

(72) Inventor: Jiyoon MOON, Busan (KR)

(21) Appl. No.: 14/888,903

(22) PCT Filed: Jul. 30, 2014
(86) PCT No.: PCT/KR2014/007003

§ 371 Date: Nov. 3, 2015

(30) Foreign Application Priority Data
Jul. 30, 2013 (KR) 10-2013-0090105

(51) Int. Cl. A21D 2/18; A21D 2/36; A21D 8/04; A21D 6/00; A23L 1/212

(52) U.S. Cl. CPC A23L 1/212; A21D 2/36; A21D 2/181; A21D 2/364; A21D 8/04; A21D 6/003; A23L 1/30; A23V 2002/00

(57) ABSTRACT

A method for producing diet food using opuntia ficus indica fruit, includes: a sour dough kneading step for producing a first sour dough by using ingredients including opuntia ficus indica fruit powder; a second sour dough kneading step for producing a second sour dough by mixing the same amount of ingredients as in the first sour dough kneading step with the first sour dough; a main dough kneading step for producing a main dough by adding water, cereals, saccharides, nuts and other ingredients to the second sour dough; a first fermentation step for fermenting the main dough by introducing the same into a fermentor; and a food producing step for producing food by using the main dough fermented by the fermentation step, wherein the second sour dough kneading step is performed under a relatively lower temperature condition than the first sour dough kneading step.

### TECHNICAL FIELD

The present invention relates to a method for producing diet food using opuntia ficus indica fruit, and more particularly, to a method for producing food which is effective on enhancing the stability of blood glucose level and also on weight reducing when taken, by appropriately treating ingredients including opuntia ficus indica fruit powder.

### BACKGROUND ART

The incidence of diabetes mellitus increases rapidly due to the environmental factors such as high energy, high fat and high protein diet, lack of exercise, stress, etc., and diabetes mellitus is indicated as one of three major diseases along with cancers and circulatory diseases.

Diabetes mellitus occurs when the physiological action of insulin is low or the physiological function of insulin is insufficient, in which glucose is detected in urine. For treating diabetes mellitus, a medicinal therapy is generally used or combined with diet and exercise. Recently, there is a growing interest in diet for treating diabetes mellitus by intake of appropriate foods, and studies are actively performed for food containing active ingredients to relieve the symptoms of diabetes mellitus.

As food containing active ingredients to relieve the symptoms of diabetes mellitus, an opuntia ficus indica fruit has been reported to have a large quantity of active ingredients to relieve the symptoms, and food using the opuntia ficus indica fruit has been actively developed.

Opuntia ficus indica is an herbaceous perennial of tropical origin and belongs to the genus Opuntia among the cactus cultivated or grown wild in Jeju-do. When freeze-dried and pulverized, the fruit of opuntia ficus indica is composed of 9.3% by weight of water, 4.24% by weight of crude protein, 1.35% by weight of crude fat, 12.12% by weight of crude ash, 3.79% by weight of crude fiber and 69.2% by weight of soluble nitrogen-free extract such as saccharides. Especially, dietary fibers contained abundantly in opuntia ficus indica fruit form highly viscose gel with increased moisture capacity to increase rapidly the viscosity, and therefore, it is difficult to produce food using opuntia ficus indica fruit.

For this reason, in the process of studying “Quality Characteristics of Bread Added with opuntia ficus indica Fruits and Antioxidant Activity on Streptozotocin-Induced Diabetic Rats” (Moon, Kyong-Ok, Department of Food Science and Biotechnology Graduate school, Kyungsung University, February 2011), the present inventor has found that when a dough containing opuntia ficus indica fruit powder mixed with a fixed amount of oligosaccharides and water is aged in an incubator at about 25° C., the viscosity of the dough can decrease greatly before and after about 12 hours. The inventor has further found that food produced by straight dough method from the aged dough containing opuntia ficus indica fruit powder has an effect on treating and preventing diabetes mellitus.

However, the method for producing food using opuntia ficus indica fruit requires a long time over 12 hours for adjusting the viscosity of dough, and uses a straight dough method which results in lacking even distribution and stability of air bubbles, and therefore the produced food does not have soft texture and high quality. Furthermore, the method is not appropriate for mass production and has a limitation in actual application.

In order to solve the above problems, the present inventor filed a patent application entitled “Manufacturing method for food added with opuntia ficus indica fruit powder,” which was granted (Korean Patent Registration No. 1206649). The method consists of a sour dough kneading step for producing a sour dough by using ingredients including a opuntia ficus indica fruit; a liquid starter dough kneading step for producing a liquid starter dough by mixing the sour dough produced by the sour dough kneading step with flour; a main dough kneading step for producing a main dough by adding ingredients to the liquid starter dough produced by the liquid starter dough kneading step; a fermentation step for fermenting the main dough produced by the main dough kneading step by introducing the same into a fermentor; and a food producing step for producing food by using the main dough fermented by the fermentation step, wherein the sour dough kneading step comprises a blending step for mixing ingredients, a stirring step for introducing the mixture formed in the blending step into a stirrer and stirring, and an aging step for introducing the sour dough stirred in the stirring step into an incubator and aging for a certain period of time; and the ingredients mixed in the blending step comprise sugars and water.

However, although the manufacturing method for food suggested in the above patent produces food with, good quality and soft texture and is suitable for mass production, it has a disadvantage that the produced food tends to become discolored and is not suitable for the production of confectionery such as biscuits.

Meanwhile, westernised diet of high energy, high fat and high protein, lack of exercise, etc, result in marked increase of body fat in a human body. The increased body fat may decrease through diet. Accordingly, studies for reducing body fat and related food have been actively performed, and food using dietary fibers and food using opuntia ficus indica fruit are examples thereof.

Since opuntia ficus indica fruit has lots of ingredients effective on reducing body fat as well as active substances effective on relieving diabetes mellitus, it is effective on reducing body fat. As mentioned above, however, dietary fibers contained abundantly in opuntia ficus indica fruit form highly viscose gel with increased moisture capacity to increase rapidly the viscosity, and therefore, it is difficult to produce food using opuntia ficus indica fruit. Furthermore, food containing opuntia ficus indica fruit powder has a problem of being discolored with the lapse of time after being produced.

### DISCLOSURE OF THE INVENTION

### Technical Problem

The present invention provides a solution to the above-mentioned problems encountered while producing food using opuntia ficus indica fruit powder. An object of the present invention is to provide a method for producing diet food using opuntia ficus indica fruit powder, in which the viscosity of dough containing opuntia ficus indica fruit powder can be adjusted within a short period of time, dough has even distribution and stability of air bubbles, and the produced food does not become discolored.

### Technical Solution

An object of the present invention is achieved by a method for producing diet food using an opuntia ficus indica fruit powder, comprising: a sour dough kneading step for producing a first sour dough by using ingredients including an opuntia ficus indica fruit; a second sour dough kneading step for producing a second sour dough by mixing the same amount of ingredients as in the first sour dough kneading step with the first sour dough produced by the first sour dough kneading step; a main dough kneading step for producing a main dough by adding water, cereals, saccharides, nuts and other ingredients to the second sour dough produced by the second sour dough kneading step; a first fermentation step for fermenting the main dough produced by the main dough kneading step by introducing the same into a fermentor; and a food producing step for producing food by using the main dough fermented by the fermentation step, wherein the second sour dough kneading step is performed under a relatively lower temperature condition than the first sour dough kneading step.

According to a preferred embodiment of the present invention, the first sour dough kneading step is performed at the temperature ranging from 90° to 95° C., while the second soar dough kneading step is performed at the temperature ranging from 0 to 5° C.

According to another preferred embodiment of the present invention, each of the first sour dough kneading step and the second sour dough kneading step comprises a blending step for producing a mixture by mixing ingredients, a stirring step for stirring the mixture produced by the blending step in a stirrer and an aging step for aging the sour dough stirred by the stirring step in an incubator for a certain period of time.

It is preferable that the ingredients used in the blending step of the first sour dough kneading step comprise 12 to 26% by weight of opuntia ficus indica fruit powder, 4 to 6% by weight of saccharides and 70 to 82% by weight of water.

Furthermore, if is preferable that the first fermentation step is performed for about 30 to 40 minutes in a fermentor in which the temperature ranging from 26 to 28° C. and the relative humidity ranging from 75 to 80% are maintained.

According to another preferred embodiment of the present invention, the food producing step comprises a shaping step and a second fermentation step.

Furthermore, it is preferable that the second fermentation step is performed for 40 to 50 minutes in a fermentor in which the temperature ranging from 36 to 38° C. and the relative humidity ranging from 80 to 85% are maintained.

### Advantageous Effects

According to the present invention, the viscosity of dough containing opuntia ficus indica fruit powder can be adjusted within a short period of time, and food can be produced from dough with even distribution and stability of air bubbles.

Furthermore, according to the present invention, since sour dough is produced through the first sour dough kneading step in a high temperature condition and the second sour dough kneading step in a low temperature condition, the viscosity of dough decreases greatly and discoloration of the produced food can be prevented.

### BRIEF DESCRIPTION OF THE DRAWINGS

FIG. 1 is a flow chart showing a method for producing diet food using opuntia ficus indica fruit according to the present invention.

FIG. 2 is a graph showing changes in blood glucose level when taken food produced according to the present invention.

FIG. 3 is a graph showing the decreasing rate of body fat when taken diet food produced according to the present invention for a long period of time.

### MODE FOR CARRYING OUT THE INVENTION

Hereinafter, the features of the present invention and the effect therefrom will be described in more details with reference to the accompanying drawings depicting preferred embodiments.

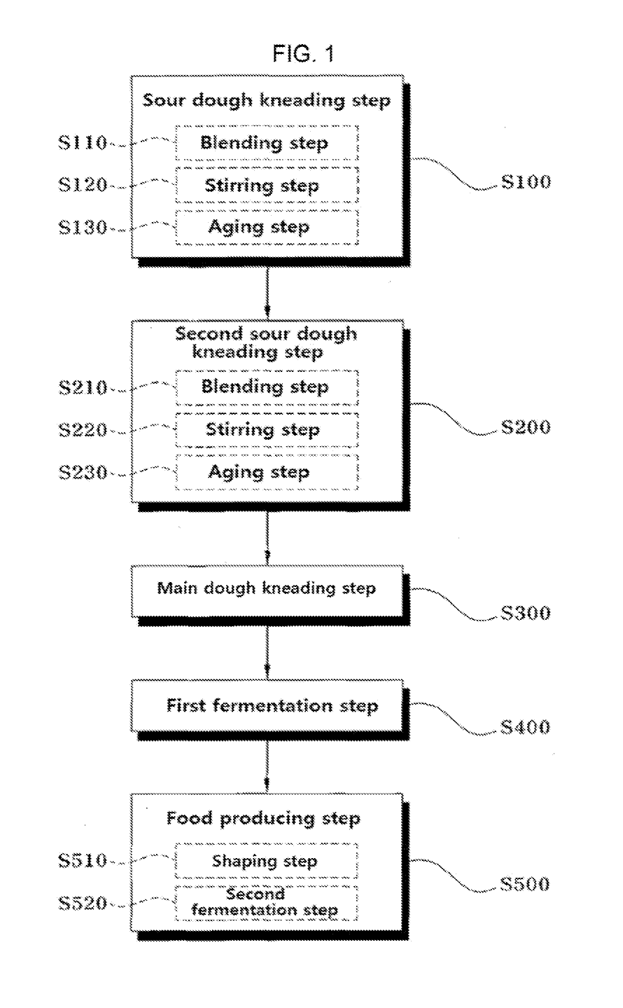

The present invention relates to a method for producing diet food effective on enhancing the stability of blood glucose level and on reducing body fat. As depicted in FIG. 1, the present invention includes a first sour dough kneading step (S100), a second sour dough kneading step (S200), a main dough kneading step (S300), a fermentation step (S400) and a food producing step (S500).

Hereinafter, each step as above is described in more details.

(1) First Sour Dough Kneading Step (S100)

To produce food, firstly dough should be prepared by mixing ingredients. According to the present invention, dough is prepared by a process for producing sour dough (sour dough kneading step) and a process for producing main dough (main dough kneading step), the process for producing sour dough comprises a first sour dough kneading step (S100) and a second sour dough kneading step (S200), and the first sour dough kneading step (S100) comprises a blending step (S110), a stirring step (S120) and an aging step (S130).

(a) Blending Step (S110)

This is a step to produce sour dough by mixing water and saccharides such as oligosaccharides or sucrose with ingredients containing opuntia ficus indica fruit powder in a stirrer. The mixing ratio of respective ingredients is preferred to be 12 to 26% by weight of opuntia ficus indica fruit powder (OFP, opuntia ficus indica fruit powder), 4 to 6% by weight of saccharides and 70 to 82% by weight of water, as shown in table I below. When opuntia ficus indica fruit powder is more than 26% by weight, dough is not suitable to produce a food, since texture becomes hard and fermentation expansion is weakened to deteriorate food quality. Furthermore, when water is more than 82% by weight, a cohesive viscoelastic substance is formed through hydration, which is difficult to treat. While water is less than 70% by weight, dough retains insufficient cohesiveness.

Warm water at about 90 to 95° C. is used in mixing the ingredients.

TABLE 1

| Ingredients | Content (% by weight) | | |
|---|---|---|---|
| OFP | 12 | 21 | 26 |
| Saccharides | 6 | 5 | 4 |
| Water | 82 | 74 | 70 |
| Total | 100 | 100 | 100 |

(b) Stirring Step (S120)

This is a step to homogenously distribute each ingredient in the mixture, which is produced in the mixing step (S110) by appropriately mixing ingredients, by introducing the mixture in a constant-temperature water bath and stirring. Stirring is performed for about 30 minutes in the constant-temperature water bath of which the temperature is maintained at 90 to 95° C., by using a stirrer rotating at a speed of about 000 rpm.

(c) Aging Step (S130)

This is a step for aging the first sour dough, which is produced by the blending step (S110) and the stirring step (S120), for a certain period of time under a condition in which appropriate temperature is maintained. To perform aging, the first sour dough produced through the blending step (S110) and the stirring step (S120) is introduced in an incubator of which the temperature is maintained at 60° C. for aging for about 3 hours.

As described above, since opuntia ficus indica fruit powder contains a large amount of dietary fibers which result in dough of high viscosity, food containing opuntia ficus indica fruit powder has poor texture and the process of producing the food becomes difficult. However, the present invention can achieve desired texture and allows following food producing process to be easily performed, since food is produced by using sour dough of reduced viscosity by mixing saccharides such as oligosaccharides or sucrose with ingredients, compounding dough in a constant-temperature water bath of high temperature by using warm water of high temperature (90 to 95° C.), and then aging the mixture in an incubator in which the temperature is maintained at 60° C. so that the viscosity of sour dough is significantly reduced in a short period of time (3 hours).

Even though sour dough of reduced viscosity is used to produce food, it also causes a problem that such food becomes discolored with the lapse of time. According to the present invention, the problem can be solved by performing a second sour dough kneading step for the sour dough produced by the first sour dough kneading step (S100). Contrary to the first sour dough kneading step (S100), in the second sour dough kneading step (S200) the aging step (S230) is performed under a low temperature condition.

(2) Second Sour Dough Kneading Step (S200)

This is a step to produce a second sour dough by mixing further opuntia ficus indica fruit powder, saccharides and water with the first sour dough of appropriate viscosity prepared in the above processes. Like the first sour dough kneading step (S100), the second sour dough kneading step (S200) also comprises a blending step (S210), a stirring step (S220) and an aging step (S230).

(a) Blending Step (S210)

This is a step to prepare source material of a second sour dough, which is mixed with the first sour dough in a weight ratio of 1:1, by adding 12 to 26% by weight of opuntia ficus indica fruit powder (OFP), 4 to 6% by weight of saccharides and 70 to 82% by weight of water, which are the same amount of ingredients used in the first sour dough kneading step (S100), to the first sour dough produced by the first sour dough kneading step (S100). In this step, cold water at about 0 to 5° C. is used in mixing the ingredients. Since the first sour dough is in high temperature condition by way of the previous aging step (S130), it is cooled down to room temperature before performing the second sour dough kneading step (S200).

(b) Stirring Step (S220)

This is a step to homogenously distribute each ingredient in the source material of second sour dough, which is produced in the mixing step (S210), by introducing the material in a constant-temperature water bath and stirring. Stirring is performed for about 30 minutes in the constant-temperature water bath of which the temperature is maintained at 0 to 5° C., by using a stirrer rotating at a speed of about 1,000 rpm.

(c) Aging Step (S230)

This is a step for aging the second sour dough, which is produced through the blending step (S210) and the stirring step (S220), for a certain period of time under a condition in which appropriate temperature is maintained. To perform aging, the second sour dough produced through the blending step (S210) and the stirring step (S220) is introduced in an incubator of which the temperature is maintained at 0 to 5° C. for aging for about 72 hours to produce the second sour dough.

According to the present invention, sour dough is produced by going through the first sour dough kneading step (S100) under the condition maintaining high temperature and the second sour dough kneading step (S200) under the condition maintaining low temperature, and therefore, the viscosity of dough decreases significantly and discoloration of food made by the dough is prevented.

As described above, the first sour dough used for producing the second sour dough is cooled down to room temperature before performing the second sour dough kneading step. However, the first sour dough produced by the first sour dough kneading step (S100) is preferred to be stored in a refrigerator of which the temperature is maintained about 0 to 5° C. and used at the temperature range to enhance the effect of the second sour dough kneading.

(3) Main Dough Kneading Step (S300)

This is a step to form a main dough by adding water, cereals, saccharides, nuts and other ingredients to the sour dough achieved through the first sour dough kneading step (S100) and the second sour dough kneading step (S200) in a stirrer. The water, cereals, saccharides, nuts and other ingredients are added so that the amount of second sour dough ranges from 5.5 to 7.5% by weight in the prepared main dough, in which the amount of opuntia ficus indica fruit powder (OFP) ranges from 0.7 to 2.0% by weight in the main dough.

According to the present invention, flour and oatmeal are used as cereals, and blueberry, cranberry, raisins, walnuts, sliced almonds, cashew nuts, sunflower seeds, hazelnuts, pumpkin seeds, etc. are used as nuts which are added to produce main dough, since these cereals and nuts have lots of dietary fibers and have an effect of excreting body fat and sugar from the body as well as have antioxidative activity due to high content of vitamins and minerals.

The composition of the main dough is represented as table 2.

TABLE 2

| Ingredients | % by weight |
|---|---|
| Flour | 30-35 |
| OFP | 0.7-2.0 |
| Saccharides | 7-9 |
| Oatmeal | 8-11 |
| Nuts | 13-17 |
| Water | 17-20 |
| Others | 12-15 |

(4) Fermentation Step (S400)

This is a step to ferment main dough, which is prepared in the main dough kneading step (S300) as above, in a fermentor in which the temperature ranging from 26 to 28° C. and the relative humidity ranging from 75 to 80% are maintained for about 30 to 40 minutes, whereby prerequisite steps for producing food are complete.

(5) Food Producing Step (S500)

This is a step to finally produce food by using main dough, which is completely fermented by the fermentation step (S400) as above by using an oven, etc. The food producing step (S500) of the present invention comprises a shaping step (S510) and a second fermentation step (S520).

(a) Shaping Step (S510)

This is a step for shaping completely fermented main dough to produce bread or confectionery in a desired form.

(b) Second Fermentation Step (S520)

This is a step to re-ferment the shaped main dough in a certain form by the shaping step (S510) in a fermentor in which the temperature ranging from 36 to 38° C. and the relative humidity ranging from 80 to 85% are maintained for 40 to 50 minutes. Through this step, food having improved texture, volume, and flavor can be produced.

In order to confirm whether food produced by the above processes becomes discolored or not with the lapse of time, 21% by weight of opuntia ficus indica fruit powder, 5% by weight of oligosaccharide and 74% by weight of warm water at 95° C. were introduced in a stirrer and mixed, the mixture was stirred for about 30 minutes in the constant-temperature water bath of which the temperature is maintained at 9° C. by using a stirrer rotating at a speed of about 1,000 rpm, and the stirred mixture was introduced in an incubator of which the temperature is maintained at 60° C. for aging for 3 hours to produce a first sour dough. To the first sour dough, the same amount of opuntia ficus indica fruit powder, oligosaccharides and water at 5° C. as used in the above step was added to produce a second sour dough, which was introduced in an incubator of which the temperature is maintained at 0 to 5° C. for aging for about 72 hours.

The aged second sour dough as above was mixed with oligosaccharides, oatmeal, blueberry, yeast and flour in a stirrer to produce a main dough, which was used to make biscuits and bread in an oven at 180° C. for 15 minutes. While the biscuits and bread were stored indoors, whether they became discolored or not was observed with the naked eyes. As a result, it could be confirmed that the bread did not become discolored at ail after 72 hours, and the biscuits did not become discolored at all after about 7 months. The result means that food produced according to the present invention has relatively long shelf life. It seems that the maintenance of color in biscuits for longer period than bread results from the less amount of water in biscuits compared with that in bread.

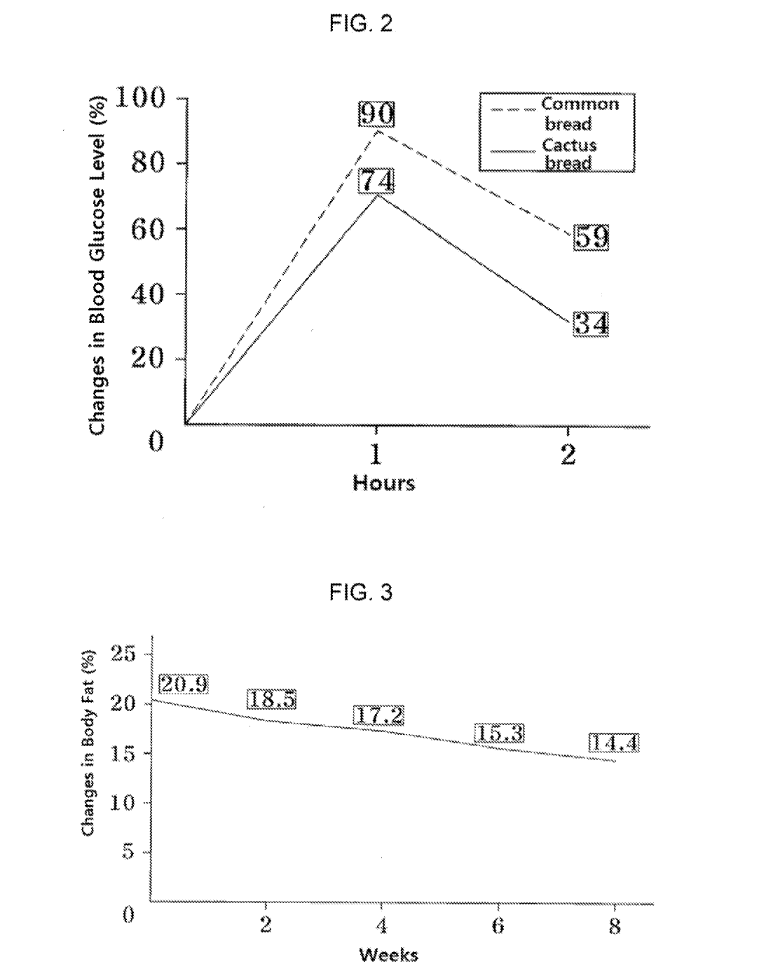

Furthermore, to confirm the effectiveness of food produced according to the present invention on treating diabetes mellitus and on reducing body fat, bread was produced according to the present invention and provided for patients suffered from diabetes mellitus and students, and the changes in blood glucose level of the patients and the changes in body fat of the students were analyzed. As shown in FIG. 2, the blood glucose level of the patients who have taken the bread produced according to the present invention decreases significantly compared with those who have taken common bread. In addition, as shown in FIG. 3, body fat determined by in body analysis decreases gradually with the lapse of time. Accordingly, it is confirmed that food produced according to the present invention is effective on treating diabetes mellitus and on reducing body fat.

As described above, according to the present invention, the viscosity of dough can be adjusted within a short period of time by forming sour dough containing opuntia ficus indica fruit powder through first and second kneading steps to produce food. Furthermore, food produced according to the present invention does not become discolored when scored for a long period of time, and has an effect on treating diabetes mellitus and on reducing body fat when taken for a long period of time.

1. A method for producing diet food using opuntia ficus indica fruit, comprising:
a sour dough kneading step for producing a first sour dough by using ingredients including opuntia ficus indica fruit powder;
a second sour dough kneading step for producing a second sour dough by mixing the same amount of ingredients as in the first sour dough kneading step with the first sour dough produced by the first sour dough kneading step;
a main dough kneading step for producing a main dough by adding watery cereals, saccharides, nuts and other ingredients to the second sour dough produced by the second sour dough kneading step;
a first fermentation step for fermenting the main dough produced by the main dough kneading step by introducing the same into a fermentor; and
a food producing step for producing food by using the main dough fermented by the fermentation step,
wherein the second sour dough kneading step is performed under a relatively lower temperature condition than the first sour dough kneading step.

2. The method according to claim 1, wherein the first sour dough kneading step is performed at the temperature ranging from 90 to 95° C. while the second sour dough kneading step is performed at the temperature ranging from 0 to 5° C.

3. The method according to claim wherein each of the first sour dough kneading step and the second sour dough kneading step comprises a blending step for producing a mixture by mixing ingredients, a stirring step for stirring the mixture produced by the blending step in a stirrer and an aging step for aging the sour dough stirred by the stirring step in an incubator for a certain period of time.

4. The method according to claim 1, wherein the ingredients used in the blending step of the first sour dough kneading step comprise 12 to 26% by weight of opuntia ficus indica fruit powder (OFP), 4 to 6% by weight of saccharides and 70 to 82% by weight of water.

5. The method according to claim 1, wherein the first fermentation step is performed for 30 to 40 minutes in a fermentor in which the temperature ranging from 26 to 28° C. and the relative humidity ranging from 75 to 80% are maintained.

6. The method according to claim 1, wherein the food producing step comprises a shaping step and a second fermentation step.

7. The method according to claim 6, wherein the second fermentation step is performed for 40 to 50 minutes in a fermentor in which the temperature ranging from 36 to 38° C. and the relative humidity ranging from 80 to 85% are maintained.
